(19) United States
(12) Patent Application Publication
(10) Pub. No.: US 2006/0040713 A1
(43) Pub. Date: Feb. 23, 2006

(54) Display apparatus

(76) Inventor: Gwang-soo Kim, Suwon-si (KR)

Correspondence Address: STANZIONE & KIM, LLP, 919 18TH STREET, N.W., SUITE 440, WASHINGTON, DC, 20006, US

(21) Appl. No.: 11/159,105

(22) Filed: Jun. 23, 2005

(30) Foreign Application Priority Data
Aug. 19, 2004 (KR) 2004-65566

(51) Int. Cl. H04B 1/38

(52) U.S. Cl. 455/566

(57) ABSTRACT

A display apparatus to wirelessly communicate with an external apparatus includes a display part to form a picture, a wireless communication unit to wirelessly communicate with the external apparatus, disposed externally with respect to the display part to communicate a signal between the external apparatus and the display part, and a coupling part to detachably couple the wireless communication unit to the display part. The display apparatus easily attaches a wireless communication unit to the display part, and detaches the wireless communication unit therefrom.

### CROSS-REFERENCE TO RELATED APPLICATIONS

This application claims the benefit under 35 U.S.C. §119 of Korean Patent Application No. 2004-65566, filed on Aug. 19, 2004, in the Korean Intellectual Property Office, the disclosure of which is incorporated herein in its entirety by reference.

### BACKGROUND OF THE INVENTION

1. Field of the Invention

The present general inventive concept relates to a display apparatus, and more particularly, to a display apparatus to wirelessly communicate with an external apparatus.

2. Description of the Related Art

A display apparatus refers to a television, a computer monitor, and the like, comprising a display module for forming a picture, and a casing supporting the display module.

The display module includes a CRT (cathode ray tube), an LCD (liquid crystal display), a PDP (plasma display panel), or another related device.

As an example of the display apparatus, Korean Patent First Publication No. 2003-58118 discloses a conventional plasma display apparatus wirelessly connected to a set-top box of a digital television to form a picture.

In the conventional plasma display apparatus, an RF antenna is fixedly placed outside a PDP screen to receive an RF signal output from the set-top box, which in turn is connected to various A/V devices and a cable.

However, such an antenna placed on a surface of the display apparatus to receive a signal from an external apparatus should be easily attachable to the display apparatus and detachable therefrom, while improving an external appearance of the display apparatus.

### SUMMARY OF THE INVENTION

Accordingly, the present general inventive concept provides a display apparatus that can easily attach a wireless communication unit to a display part, and detach the wireless communication unit therefrom.

Additional aspects and/or advantages of the present general inventive concept will be set forth in part in the description which follows and, in part, will be obvious from the description, or may be learned by practice of the present general inventive concept.

The foregoing and/or other aspects and advantages of the present general inventive concept are achieved by providing a display apparatus that can wirelessly communicate with an external apparatus, the display apparatus comprising a display part to form a picture, a wireless communication unit, to wirelessly communicate with the external apparatus, disposed outside of the display part to communicate a signal between the external apparatus and the display part, and a coupling part to detachably couple the wireless communication unit to the display part.

The wireless communication unit may comprise a wireless communication module, to wirelessly communicate with the external apparatus to communicate the signal between the external apparatus and the display part, and a front cover and a back cover to support the wireless communication module.

The wireless communication unit may further comprise an indicating part electrically connected to the wireless communication module to turn on when the wireless communication module receives the signal from the external apparatus.

The wireless communication unit may further comprise an upper cover provided at an upper part of the front cover and the back cover to transmit light from the indicating part and to emit the light externally.

The coupling part may comprise a locking part provided in one of a back of the display part and the wireless communication unit, and an engaging part provided in the other of the back of the display part and the wireless communication unit and to engage with the locking part.

The display apparatus may comprise a fixing bracket placed on the back of the display part, and on which one of the locking part and the holding part is formed.

An inclined surface may be formed on the back of the display part on which the fixing bracket is installed, and a bending part may be formed on the wireless communication unit corresponding to the inclined surface.

Coupling bosses may be formed on the back of the display part, screw insertion holes may be formed on the fixing bracket corresponding to the coupling bosses, and screws may be inserted into the screw insertion holes to couple with the coupling bosses.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view of a display apparatus according to an embodiment the present general inventive concept;

FIG. 2 is a rear perspective view of the display apparatus of FIG. 1; and

FIG. 3 is an exploded perspective view of a wireless communication of the display apparatus of FIGS. 1 and 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described in order to explain the present general inventive concept while referring to the figures.

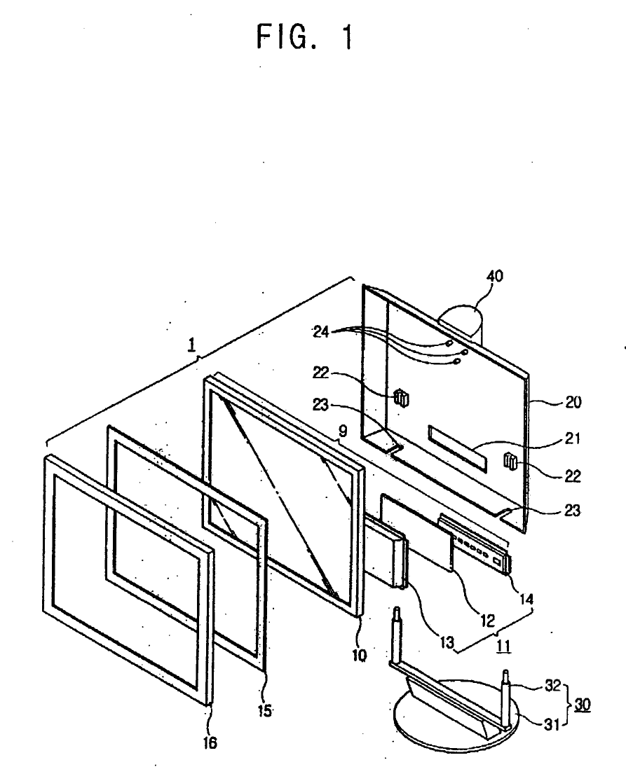

FIG. 1 is an exploded perspective of a display apparatus according to an embodiment of the present general inventive concept. Referring to FIG. 1, the display apparatus comprises a display part 1 to form a picture, and a base part 30 to support the display part 1.

The display part 1 can comprise a display module 9 to form the picture, a front casing 16 and a back casing 20 to support the display module 9.

The front casing 16 supports a front portion of the display module 9, and the back casing 20 supports a back portion of the display module 9. Between the front casing 16 and the display module 9 an optical filter 15 can be provided.

The display module 9 can comprise a PDP (plasma display panel) assembly 10 to form the picture, and a main PCB (printed circuit board) assembly 11 to drive the PDP assembly 10. The display module 9 is not limited to the PDP assembly 10, and may alternatively comprise an LCD (liquid crystal display) assembly, a CRT (cathode ray tube) assembly, or the like.

The optical filter 15 protects a front portion of the PDP assembly 10 and blocks EMI (electromagnetic interference).

The main PCB assembly 11 can comprise a main PCB 12 provided with a plurality of control components, and a supporting bracket 13 to support the main PCB 12 at the PDP assembly 10. A first side of the main PCB 12 is coupled to a port part 14 externally exposed through a port part mounting hole 21 formed at the back casing 20. The port part 14 comprises a plurality of ports, such as for example, a power input terminal and a cable connecting terminal.

The base part 30 can comprise a base member 31 to support the display part 1 at an installation surface, and a pair of supports 32 provided in an outward direction from the base member 31.

The supports 32 are inserted into the back casing 20 of the display part 1 through a corresponding pair of support insertion openings 23 formed on a lower part of the back casing 20, and coupled to a corresponding pair of support coupling parts 22 provided inside of the back casing 20.

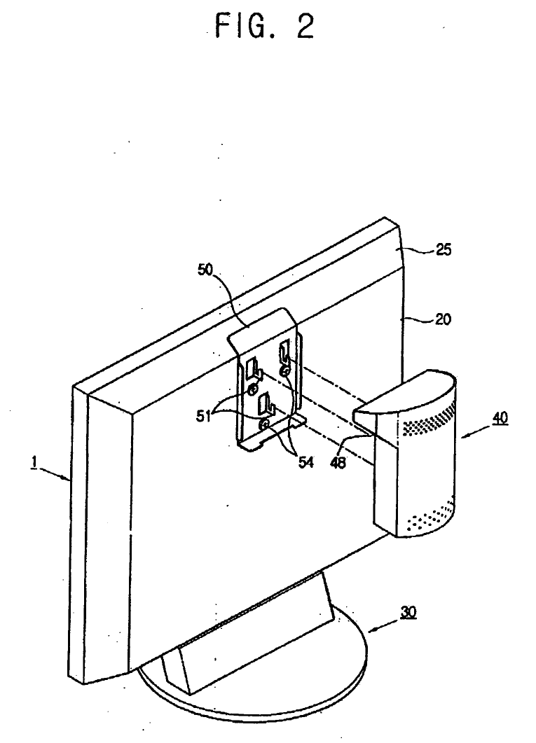

FIG. 2 is a rear perspective view of the display apparatus of FIG. 1. Referring to FIGS. 1 and 2, a wireless communication unit 40 is placed on a back of the display part 1 through which an external apparatus and the display part 1 can wirelessly communicate with each other. Hereinbelow, a set-top box will be referred to as an example of the external apparatus to wirelessly communicate with the display part 1 thorugh the wireless communication unit 40, but the external apparatus is not limited to the set-top box. Here, the set-top box will not be described in detail nor shown in a drawing since the set-top box is known in the art.

The wireless communication unit 40 is detachably coupled to the back casing 20 of the display part 1 by a coupling part to be described later, and a bending part 48 can be formed at the wireless communication unit 40 corresponding to an inclined surface 25 of the back casing 20. Thus, the bending part 48 contacts the inclined surface 25 of the back casing 20 when the wireless communication unit 40 is coupled to the back casing 20.

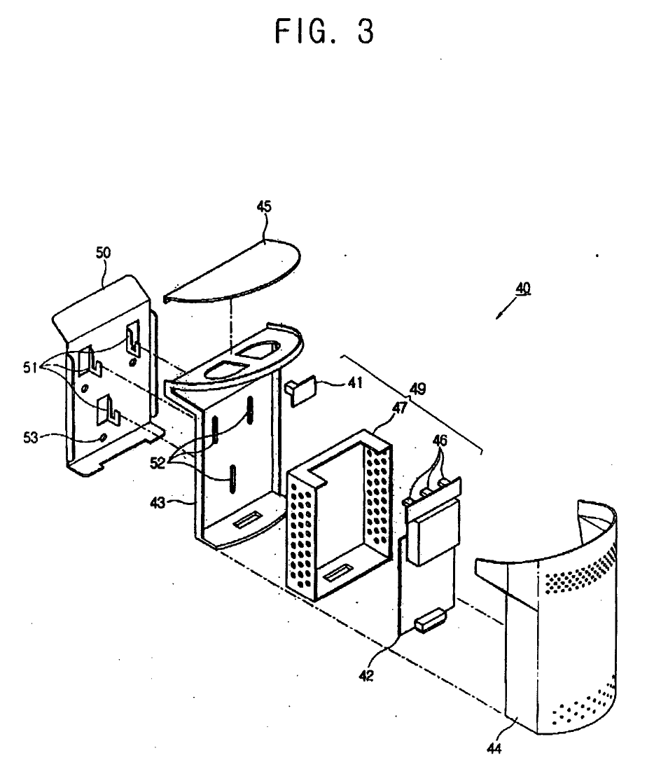

FIG. 3 is an exploded perspective view of the wireless communication unit 40. Referring to FIGS. 1-3, the wireless communication unit 40 comprises a wireless communication module 49 to wirelessly communicate a signal with the set-top box, a front cover 43 to support a front portion of the wireless communication module 49, a back cover 44 to support a back portion of the wireless communication module 49, and an upper cover 45 disposed at an upper part of the front cover 43 and the back cover 44. The upper cover 45 can be semi-transparent to allow light to pass therethrough.

The wireless communication module 49 comprises a sending/receiving module 41 to wirelessly send/receive the signal to/from the set-top box and a sub PCB 42 electrically connected to the sending/receiving module 41 and the main PCB assembly 11 of the display part 1.

A sub PCB supporting bracket 47 can be provided between the sub PCB 42 and the front cover 43 to support the sub PCB 42 at the front cover 43, and an LED (light emitting diode) part 46 is provided in the sub PCB 42 as an indicating part being turned on to indicate when the sending/receiving module 41 receives the signal from the set-top box.

The LED part 46 is turned on when the sending/receiving module 41 receives the signal from the set-top box, to generate light. As the light generated from the LED part 46 passes through openings of the front cover 43, and is then emitted externally through the semi-transparent upper cover 45, a user can confirm that the wireless communication unit 40 receives the signal from the set-top box.

The sub PCB 42, supported by the sub PCB supporting bracket 47, relays the signal between the sending/receiving module 41 and the main PCB assembly 11 and controls the LED part 46 to turn on/off.

The coupling part comprises a locking part 51 of a fixing bracket 50 provided at the back casing 20 of the display part 1, and an engaging part 52 provided at the front cover 43 of the wireless communication unit 40 to be engaged with the locking part 51.

The fixing bracket 50 can correspond to the inclined surface 25 of the back casing 20, and can be installed on a back of the back casing 20 by screws 54.

Screw insertion holes 53 can be formed in the fixing bracket 50 corresponding to a plurality of coupling bosses 24 formed on the back casing 20 of the display part 1. Thus the screws 54 pass through the screw insertion holes 53 and are coupled to the coupling bosses 24 of the back casing 20.

The locking part 51 can be provided as one or more hooks on the fixing bracket to couple with the front cover 43 of the wireless communication unit 40, and the engaging part 52 is formed on the front cover 43 of the wireless communication unit 40 corresponding to the locking part 51, so that the locking part 51 can be inserted into the engaging part 52. Although the locking part 51 is described as being provided at the back casing 20 of the display part 1, and the engaging part 52 is described as being provided at the front cover 43 of the wireless communication unit 40, the locking part 51 and the engaging part 52 are not limited to this configuration. Alternatively, the locking part 51 may be provided at the front cover 43 of the wireless communication unit 40, and the engaging part 52 may be provided at the back casing 20 of the display part 1.

In the display apparatus according to the present general inventive concept as described above, the wireless communication unit 40 can be easily attached to the back of the display part 1 by inserting the locking part 51 formed on the back casing 20 of the display part 1 into the engaging part 52 of the wireless communication unit 40. Then, the display part 1 can wirelessly communicate with the external apparatus, such as the set-top box.

Meanwhile, the wireless communication unit 40 can be easily detached from the display part 1 by gripping the wireless communication unit 40 and releasing the locking part 51 of the fixing bracket 50 from being inserted into the engaging part 52 of the wireless communication unit 40.

Further, a user can have an improved external appearance of the display apparatus since the wireless communication unit 40 is mounted on the back of the display part 1.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus to wirelessly communicate with an external apparatus, the display apparatus comprising:
a display part to form a picture;
a wireless communication unit to wirelessly communicate with the external apparatus and disposed externally with respect to the display part to communicate a signal between the external apparatus and the display part; and
a coupling part to detachably couple the wireless communication unit to the display part.

2. The display apparatus according to claim 1, wherein the wireless communication unit comprises a wireless communication module to wirelessly communicate with the external apparatus to communicate the signal between the external apparatus and the display part, and a front cover and a back cover to support the wireless communication module.

3. The display apparatus according to claim 2, wherein the wireless communication unit further comprises an indicating part electrically connected to the wireless communication module that turns on when the wireless communication module receives the signal from the external apparatus.

4. The display apparatus according to claim 3, wherein the wireless communication unit further comprises an upper cover provided at an upper part of the front cover and the back cover to transmit light from the indicating part and emit the light externally.

5. The display apparatus according to claim 4, wherein the coupling part comprises a locking part provided at one of a back of the display part and the wireless communication unit, and an engaging part provided in the other of the back of the display part and the wireless communication unit to engage with the locking part.

6. The display apparatus according to claim 5, comprising:
a fixing bracket installed at the back of the display part, and on which one of the locking part and the holding part is formed.

7. The display apparatus according to claim 6, wherein an inclined surface is formed at the back of the display part on which the fixing bracket is installed, and a bending part is formed at the wireless communication unit corresponding to the inclined surface.

8. The display apparatus according to claim 7, wherein coupling bosses are formed at the back of the display part, screw insertion holes are formed at the fixing bracket corresponding to the coupling bosses, and screws are inserted into the screw insertion hole to couple with the coupling bosses.

9. The display apparatus according to claim 1, wherein the coupling part comprises a locking part provided at one of a back of the display part and the wireless communication unit, and an engaging part provided in the other of the back of the display part and the wireless communication unit to engage with the locking part.

10. The display apparatus according to claim 9, further comprising:
a fixing bracket disposed at the back of the display part, and on which one of the locking part and the holding part is formed.

11. The display apparatus according to claim 10, wherein an inclined surface is formed at the back of the display part on which the fixing bracket is installed, and a bending part is formed at the wireless communication unit corresponding to the inclined surface.

12. The display apparatus according to claim 11, wherein coupling bosses are formed at the back of the display part, screw insertion holes are formed at the fixing bracket corresponding to the coupling bosses, and screws are inserted into the screw insertion holes to couple with the coupling bosses.

13. A display apparatus to wirelessly communicate with an external apparatus, comprising:
a display to form an image corresponding to a received image signal; and
a wireless communication unit attachable to and detachable from the display to wirelessly receive the image signal from the external apparatus and provide the received image signal to the display.

14. The display apparatus according to claim 13, wherein the wireless communication unit comprises an indicating part to indicate when the wireless communication unit receives the signal from the external apparatus.

15. The display apparatus according to claim 14, wherein the indicating part is an LED (light emitting diode) to generate light when the wireless communication unit receives the signal from the external apparatus.

16. The display apparatus according to claim 13, wherein the wireless communication unit is attachable to and detachable from a back surface of the display.

17. The display apparatus according to claim 16, wherein the wireless communication unit comprises a bended portion corresponding to an inclined portion of the back surface of the display.

18. The display apparatus according to claim 13, wherein one of the display and the wireless communication unit comprises a protruding portion, the other one of the display and the wireless communication unit comprises an accommodating portion to accommodate the protruding portion, and the protruding portion and the accommodating portion lock together to attach the wireless communication unit to the display.

19. The display apparatus according to claim 18, wherein the protruding portion comprises one or more hooks protruding from the one of the display and the wireless communication unit to hook and lock together with the accommodating portion.

20. The display apparatus according to claim 13, wherein the display comprises a main PCB assembly control the display to form the image corresponding to the received image signal.

21. A wireless communication device attachable to and detachable from a display apparatus to wirelessly communicate signals between the display apparatus and an external apparatus, comprising:
a wireless communication module to wirelessly communicate signals with the external apparatus; and
a coupling unit to attach to and detach the wireless communication device to and from the display apparatus.
